(19) United States
(12) Patent Application Publication
(10) Pub. No.: US 2013/0112536 A1
(43) Pub. Date: May 9, 2013

(54) SLIDE SWITCH

(71) Applicants: Dhaval Shah, Fremont, CA (US); Jared M. Kole, San Jose, CA (US); Michael Wittenberg, Sunnyvale, CA (US)

(72) Inventors: Dhaval Shah, Fremont, CA (US); Jared M. Kole, San Jose, CA (US); Michael Wittenberg, Sunnyvale, CA (US)

(73) Assignee: Apple Inc., Cupertino, CA (US)

(21) Appl. No.: 13/288,244

(22) Filed: Nov. 3, 2011

(51) Int. Cl. H01H 3/20; H01H 11/00

(52) U.S. Cl. 200/331; 29/622

(57) ABSTRACT

One embodiment may take the form of a slide switch for electronic devices having a connecting rod and a first joint coupling a first end of the connecting rod to a button. The first joint allows rotation of the connecting rod relative to the button. A second joint couples a second end of the connecting rod to a support structure. The second joint allows the connecting rod to rotate relative to the support structure. The second joint is offset laterally from the button. The button is constrained to move along a straight path between a first resting position and a second resting position. The connecting rod is configured to resist displacement of the button from one of the first or second resting positions until the button passes a threshold displacement distance, at which point the connecting rod snaps the button into the other resting position.

### FIELD OF THE INVENTION

The present application is related to switches and, more particularly, to slide switches for electronic devices.

### BACKGROUND

Switches are commonly implemented to break and/or complete electrical circuits. Switches come in a variety of different shapes and sizes. In some cases, switches may be configured to click or snap into position. The snap may provide tactile feedback to a user indicating that the circuit has been opened or closed. Different mechanisms have been implemented to achieve the tactile feedback. For example, detents may be used to create the snapping functionality in some cases. The detents may also help to hold the switch in either a closed or opened position. Typically, the mechanical structure that provides the snap functionality adds depth to the switch. That is, the switch profile may be increased by the mechanism that provides the snap functionality. Additionally, relatively sensitive switch components may generally be located behind or under the button thereby further increasing the depth of the switch and limiting the robustness of the switch against a drop.

### SUMMARY

An over-center, off-axis slide switch provides tactile feedback to a user and allows both mechanical and electrical components to be located outside the depth of the button of the switch. In particular, one embodiment may take the form of a slide switch for electronic devices having a connecting rod and a first joint coupling a first end of the connecting rod to a button. The first joint is configured to allow rotation of the connecting rod relative to the button. A second joint couples a second end of the connecting rod to a support structure. The second joint is configured to allow the connecting rod to rotate relative to the support structure and the second joint is offset laterally from the button. The button is constrained to move along a straight path between a first resting position and a second resting position and the connecting rod is configured to resist displacement of the button from one of the first or second resting positions until the button passes a threshold displacement distance, at which point the connecting rod snaps the button into the other resting position.

Another embodiment may take the form of a method of manufacturing a slide switch. The method includes positioning a button within a housing and coupling a connecting rod to the button with a revolute joint. The method also includes coupling the connecting rod to a support structure with a second revolute joint so that the connecting rod extends laterally from the button and the support structure is located adjacent to the button. Further the method includes selectively coupling the connecting rod to one of at least two electrically conductive members.

While multiple embodiments are disclosed, still other embodiments of the present invention will become apparent to those skilled in the art from the following Detailed Description. As will be realized, the embodiments are capable of modifications in various aspects, all without departing from the spirit and scope of the embodiments. Accordingly, the drawings and detailed description are to be regarded as illustrative in nature and not restrictive.

### BRIEF DESCRIPTION OF THE DRAWINGS

FIG. 1 illustrates a slide switch having a connecting rod extending laterally therefrom.

FIG. 2 illustrates the slide switch of FIG. 1 with its connecting rod bent due to movement of the switch.

FIG. 3. illustrates a slide switch in accordance with an alternative embodiment.

FIG. 4 is a partial cross-sectional view of the slide switch of FIG. 3 taken along line IV-IV.

FIG. 5 illustrates an underside view of a button of another slide switch having a spring coupled with the button.

FIG. 6 illustrates an underside view of another button of yet another slide switch having a spring coupled with the button with dual connecting rods.

FIG. 7A illustrates a slide switch in a first position and having a telescoping rod extending laterally therefrom.

FIG. 7B illustrates the slide switch of FIG. 7A in a second position with the rod collapsed.

FIG. 7C illustrates the slide switch of FIG. 7A in a third position with the rod extended.

FIG. 8 illustrates an example electronic device in which a slide switch may be implemented.

### DETAILED DESCRIPTION

One embodiment may take the form of a slide switch that is constrained to move linearly within its housing. In particular, the slide switch may be constrained to move linearly on a track for example. A flexible metal piece or flexure is attached to the housing by a pin or revolute joint. This pin joint is located to the side of the button, in the wide axis of the button. The location of the joint may be used to fine-tune the tactile feedback and functionality of the switch. In some embodiments, the pin joint may be located at or near the center point of the sliding switch's range of motion. The other end of the flexure is coupled to the button with a pin joint.

As the button moves from either extreme of its range of motion, the distance between the pin joints initially decreases and the flexure resists the movement of the button and bends. Once the button reaches a threshold distance, such as the center between the extremes of the range of motion, the flexure snaps over, extends out of its bent position and pushes the button to the opposite extremity. This creates a “click” feel. Additionally, the flexure then holds the button in position and resists the return of the button to its previous position.

Further, the flexure may provide the electrical connection for the switch. In particular, electrical contact can be made anywhere along the length of the flexure. Hence, when the flexure snaps over, it may break an electrical connection at one side and complete an electrical connection with the other side. In other embodiments, the electrical connections may be the button itself. That is, the button may be configured to make the electrical connections that complete a circuit.

In still other embodiments, different mechanisms may be implemented that achieve the desired initial resistance and snap functionality. It should be appreciated that the resistance generally is based upon on the distance between the joints. In one embodiment, a captured piston and compression spring may be used with or instead of the flexure with the cylinder and spring being located either on the housing side or button side of the mechanism. Other embodiments may include dual-pistons and compressed springs. In the duel piston embodiment, movement of the button may be constrained to a straight line by the dual pistons and compressed springs rather than a track. Still other embodiments may take the form of a telescoping rod with a compressing spring.

Generally, the switch may have a low-profile relative to conventional switches in the area of the button, which is often where electronic products are most constrained. The switch provides flexibility in electrical wiring, as the flexure can be any suitable length and an electrical connection may be made or broken at any point along its length. Additionally, the thickest portion of the switch (e.g., where the mechanical components are located) may be moved a distance away from the button to an area that may have more space.

In addition, the sensitive switch components may be moved out from under the button so that they are not directly impacted in a drop. Moreover, the force applied as the button moves can be made symmetrical over the centerline of the button without being affected by traditional spring or slider manufacturing tolerances. Further, the tactility or tactile feedback can be tuned based on the flexure or piston position to give more precise feedback relative to traditional slide switches. Waterproofing of the switch may also be achieved through proper seating of the button and providing o-ring or gasket seals.

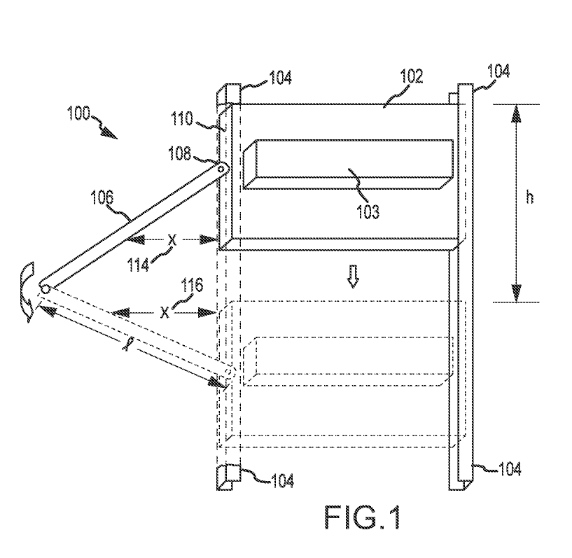

Turning to the drawings and referring to FIG. 1, a slide switch 100 is illustrated in accordance with an example embodiment. Generally, the slide switch 100 includes a button 102 that is constrained to move linearly. In particular, the button 102 may be constrained by a housing that includes tracks 104 that limit the movement of the button to a straight line. A portion 103 of the button with which a user may interact may project outward from the top of the button 102. The button 102 may have a generally rectangular shape with the width of the button and the length of the button being approximately the same size. That is, the length and the width are on the same order as each other. With reference to the button 102, the length of the button corresponds to the direction of the button's travel.

A connection rod 106 is coupled to the button 102 with a pin or rotation joint 108 which allows for pivoting or rotation of the connection rod relative to the button. The connection rod 106 may take various forms as will be discussed in greater detail below. In FIG. 1, the connection rod 106 takes the form of a metal rod 106 that has a fixed length I and is configured to conduct electrical current. In other embodiments, the connection rod 106 may be made of plastic. Further, in some embodiments, the connection rod 106 may include both plastic and metal portions. For example, the connection rod may have a plastic core with metal coatings over portions of the plastic core that are configured to conduct electrical current.

The pin joint 108 may be located in any suitable position on the button 102. For example, the pin joint 108 may be located near the middle of the button 102 on an outer edge 110 of the button. In other embodiments, the pin joint 108 may be located in a different location on the outer edge 110. In still other embodiments, the pin joint 108 may be located on an underside of the button. For example, the pin joint 108 may be located near the center of the button 102 on its underside.

A second pin joint 112 couples the connection rod 106 to a support structure. The support structure may take various different forms. In some embodiments, the support structure may fix the joint 112 in a position relative to the button 102. For example, in some embodiments, the support structure 112 may be an electronic device housing. In other embodiments, the support structure 112 may take the form of a housing of the switch 100. In still other embodiments, the support structure may allow movement of the joint 112 along an axis, as will be discussed below.

The second pin joint 112 is offset from the button 102. That is, the second joint 112 is adjacent to the button 102 and not part of the depth of the button. Additionally, electrical contacts 114, 116 may be located outside the depth of the button 102. In particular, the electrical contacts 114, 116 may be positioned between the second joint 112 and the button 102 such that the contacts 114, 116 make contact or disconnect with the connection rod 106 when the button 102 is moved. It should be appreciated that that the rod 106 may engage or disengage the electrical contacts 114, 116 at any location along its length. Hence, the connection rod 106 may be an integral part of the electrical circuit of the switch 100.

The engagement and or disengagement with the contacts 114, 116 may take any suitable form. For example, the contacts 114, 116 may take the form of conductive leaf springs that are configured to maintain contact with the conductive rod 106 while the button is in a particular position. In other embodiments, the contacts 114, 116 may be poles or pins with which the rod 106 makes contact. In still other embodiments, the contacts 114, 116 may take the form of conductive pads that the connection rod 106 rest against.

Returning again to FIG. 1, as the button 102 is moved from a first position 120 to a second position 122 (shown in the dashed lines), the pin joints 108, 112 allow for rotation of the connection rod 106 about the joints. The displacement of the button 102 between one position to another may be represented by the distance h. Due to the constrained linear movement of the button 102 and the fixed position of the second pin joint 112 relative to the button, the distance between the second joint 112 and the button reaches a minimum at or near the mid-point of travel. The Pythagorean theorem may be used to calculate the change in distance between the button 102 and the second joint 112 as the button moves from the first position to a halfway point between the first and second positions 120, 122. Specifically, the change in the distance between the button and the second joint 112 may be represented by:

Δl₁=\sqrt{l²₂+(\sqrt{1/2}h)²−l₂},

where l₁ represents the length of the connecting rod 106 and corresponds to the distance between the joints when the button is at either the first or second position 120, 122; ½h represents the distance from the first or second position to the halfway point (e.g., where the button is halfway between the first and second positions); and l₂ represents a distance between the joints at the halfway point.

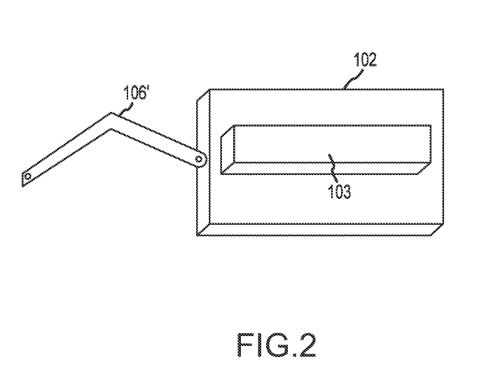

In the example of FIG. 1, the connecting rod 106 bends or flexes to accommodate the movement of the button, as shown in FIG. 2. In particular, FIG. 2 illustrates the conductive rod 106′ as being bent near the halfway point during movement of the button. The rod initially resists movement of the button and the bending of the rod 106 provides resistance to the movement of the button 102. At or near the halfway point of the range of motion of the button a threshold distance is reached at which the conductive rod 106 stops resisting displacement of the button 102 and rapidly pushes the button into a position to provide the snap tactile feedback to a user. This was previously described as the rod snapping over. Hence, the deformation of the rod through movement of the button builds potential energy which is released when the button passes a threshold distance.

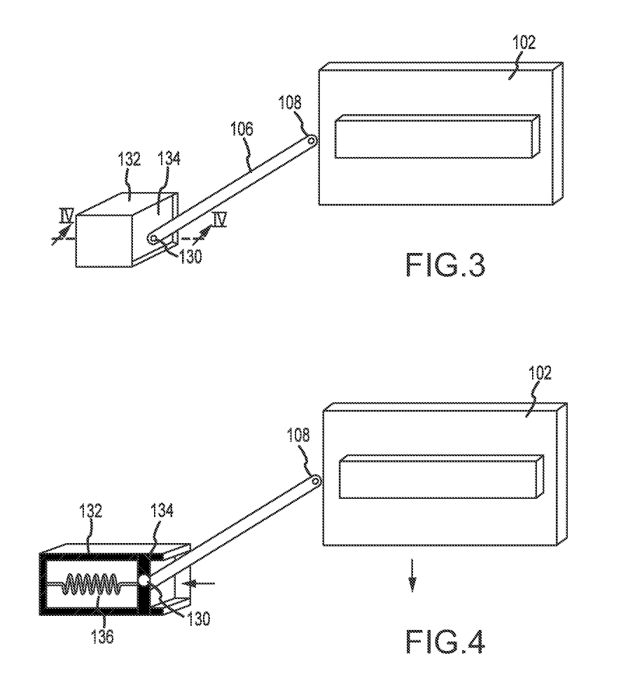

Other embodiments may be implemented in which the connecting rod 106 does not bend and/or store potential energy. FIG. 3 illustrates an embodiment where a second joint 130 couples the connecting rod 106 to a support structure 132. In particular, the second joint 130 couples the rod 106 to a piston 134 of the support structure 132. FIG. 4 illustrates a cross-sectional view of the support structure 132 taken along line IV-IV in FIG. 3. The piston 134 is coupled to a compressed spring 136 that stores and releases potential energy when the button 102 is moved. Again, the pin joints 130 and 108 allow rotation of the rod 106 about the joints during movement of the button 102. Further, the connecting rod 106 may electrically couple and decouple with electrical contacts (not shown), as discussed above.

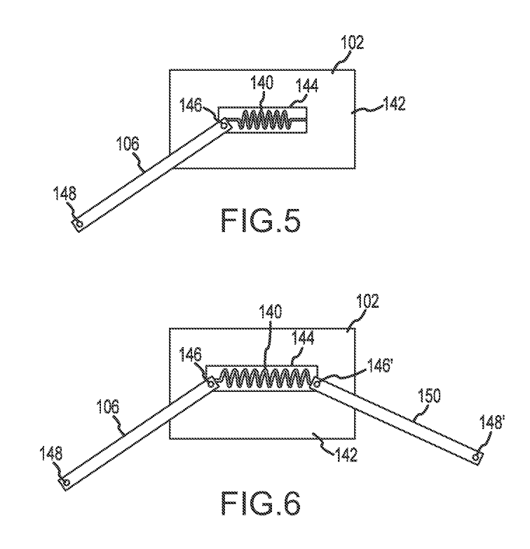

FIG. 5 illustrates an alternative embodiment where the button 102 houses a compressed spring 140 to which the connecting rod 106 is coupled. FIG. 5 shows the underside 142 of the button 102 as having a spring housing 144 in which the compressed spring 140 resides. The spring housing 144 may take any suitable form such as a cylinder, an aperture in the button's underside 142, and so forth. A first pin joint 146 couples the rod 106 to the compressed spring 140 and second pin joint 148 couples the rod 106 to a support structure.

As the button 102 moves linearly, the spring 140 is compressed. In this embodiment, the distance between the joints 146, 148 does not change. As the spring 140 compresses it stores potential energy that is released once the button 102 passes a threshold distance to provide the snapping effect. Thus, it is the spring 140 that resists displacement of the button and snaps the button into position.

FIG. 6 illustrates yet another embodiment having dual rods 106, 150 coupled to the spring 140 housed within the button 102. The second rod 150 may be positioned on the opposite side of the button 102 from the first rod 106. Generally, the second rod 150 may have the same characteristics as the first rod 106. That is, it may be made of the same material, have the same size and shape and may respond similarly to the first rod when pressure is applied through movement of the button. In this embodiment, the movement of the button may be constrained by the rods 106 142.

In alternatives for the duel rod embodiment, two springs may be provided, one for each rod. The springs may be separated by a septum or wall within the spring housing 144. In still other embodiments, the springs may not be located at the button side of the rods. That is, the springs may be located in a spring housing external to the button and may couple to the second joints 148, 148′. Generally, the dual rod and/or duel spring embodiments may provide force symmetry so that the button moves linearly. As such, the button 102 may not be constrained by tracks or other structure, except for the rods and the springs.

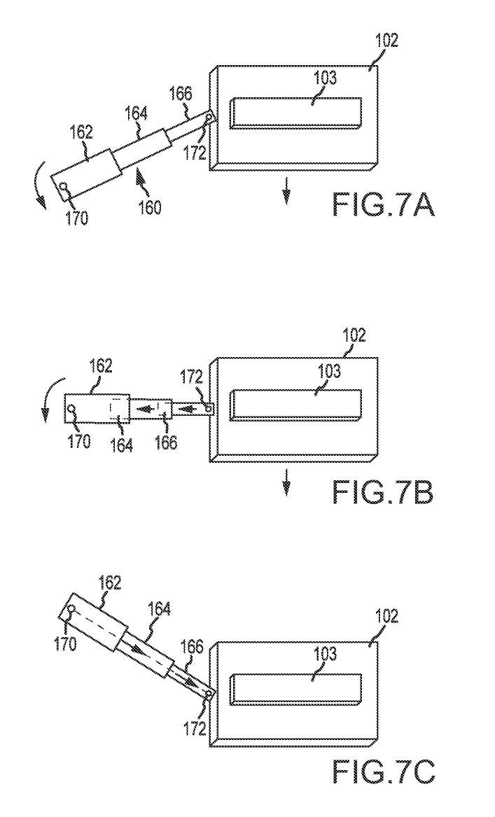

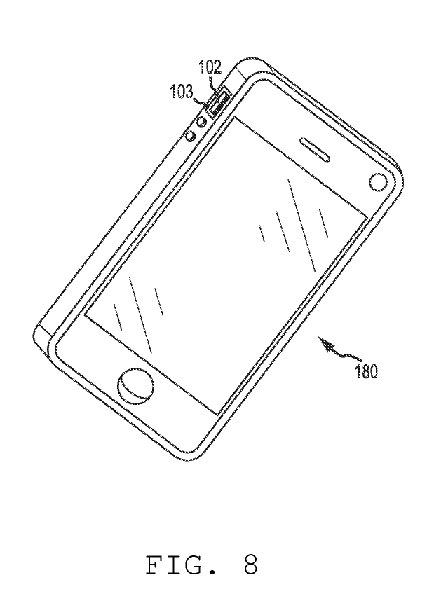

FIG. 7A illustrates yet another embodiment wherein a connecting rod takes the form of a telescoping rod 160. The telescoping rod 160 includes extendable segments 162, 164, 166 that collapse and nest within an adjacent and larger segment. For example, a smallest segment 166 may collapse and nest within a medium sized segment 164 which may collapse and nest within a large segment 162. It should be appreciated that the telescoping rod 160 may include more or fewer segments than shown.

The segments 162, 164, 166 also house a compressible spring that forces the telescoping rod 160 into an extended position. As the button 102 is moved linearly, the telescoping rod 160 collapses and the spring within the rod is compressed and stores energy, as shown in FIG. 7B. Once the button passes a threshold (e.g., past the halfway point between first and second positions) the spring pushes the rod into an extended position, forcing the button into a position and providing the snap feedback to a user, as shown in FIG. 7C. Throughout the range of motion, the rod rotates about pin joints 170, 172.

FIG. 8 illustrates an example electronic device 180 in which an embodiment of the slide switch may be implemented. As may be appreciated, only the portion 103 of the button 102 with which a user interfaces may be exposed externally from a housing 182 of the device 180. Further, it should be appreciated that the slide switch may be implemented in a variety of different electronic devices including but not limited to, smart phones, cellular phones, portable media devices, cameras, televisions, stereos, tablet computers, notebook computers, and so forth.

The foregoing describes some example embodiments of slide switches that allow both the mechanical and electrical components of the switch to be outside the depth of a button of the switch. Although the foregoing discussion has presented specific embodiments, persons skilled in the art will recognize that changes may be made in form and detail without departing from the spirit and scope of the embodiments. For example, a dual telescoping rods may be implemented. Accordingly, the specific embodiments described herein should be understood as examples and not limiting the scope thereof.

1. A slide switch for electronic devices comprising:
a connecting rod;
a first joint coupling a first end of the connecting rod to a button, the first joint configured to allow for rotation of the connecting rod relative to the button; and
a second joint coupling a second end of the connecting rod to a support structure, the second joint configured to allow the connecting rod to rotate relative to the support structure, the second joint being offset laterally from the button,
wherein the button is constrained to move along a straight path between a first resting position and a second resting position and, wherein further, the connecting rod is configured to resist displacement of the button from one of the first or second resting positions until the button passes a threshold displacement distance, at which point the connecting rod snaps the button into the other resting position.

2. The slide switch of claim 1, wherein the connecting rod comprises a flexible metal member configured to deform in one dimension.

3. The slide switch of claim 1, wherein the support structure comprises a housing of an electronic device.

4. The slide switch of claim 1, wherein the support structure comprises a piston, wherein the piston is coupled to a compressed spring that is configured to displace as the button is displaced from one of the first or second resting positions.

5. The slide switch of claim 1, wherein the connecting rod comprises a telescoping rod.

6. The slide switch of claim 5, wherein the telescoping rod comprises a compressed spring.

7. The slide switch of claim 1, wherein the button comprises a compressed spring and the first joint couples the connecting rod to the spring.

8. The slide switch of claim 7 further comprising:
a second connecting rod;
a third joint rotatably coupling a first end of the second connecting rod to the compressed spring;
a fourth joint rotatably coupling a second end of the second connecting rod to a support structure.

9. The slide switch of claim 1, wherein the button moves within a track.

10. The slide switch of claim 1, wherein at least one of the first and second joints is a revolute joint.

11. The slide switch of claim 1, wherein the second joint is positioned at approximately a center point between the first resting position and the second resting position of the button.

12. The slide switch of claim 1, wherein the first joint is positioned near the middle of a side of the button.

13. The slide switch of claim 1, wherein the first joint is offset from the middle of a side of the button.

14. The slide switch of claim 1, wherein the first joint is positioned near middle of a backside of the button.

15. The slide switch of claim 1, wherein the connecting rod touches an electrical contact of the switch to complete a circuit.

16. The slide switch of claim 1, wherein the button touches an electrical contact of the switch to complete a circuit.

17. The slide switch of claim 1, wherein movement of the button is constrained by tracks.

18. The slide switch of claim 1, wherein movement of the button is constrained by dual rods located on opposite sides of the button.

19. A method of manufacturing a slide switch comprising:
positioning a button within a housing;
coupling a connecting rod to the button with a revolute joint;
coupling the connecting rod to a support structure with a second revolute joint, wherein the connecting rod extends laterally from the button and the support structure is located adjacent to the button; and
selectively coupling the connecting rod to one of at least two electrically conductive members.

20. The method of claim 19, wherein positioning the button within the housing comprises mounting the button within tracks so that the movement of the button is linearly constrained.

21. The method of claim 19, wherein coupling the connecting rod to a support structure comprises coupling the connecting rod to a piston and a spring assembly.

22. The method of claim 19, wherein coupling the connecting rod to the button comprises coupling the rod to a spring co-located with the button.
